(19) United States
(12) Patent Application Publication
(10) Pub. No.: US 2013/0131930 A1
(43) Pub. Date: May 23, 2013

(54) STROLLERS FOR PREVENTING HARM TO AN INFANT WHEN AN ACCIDENTAL EVENT OCCURS TO THE STROLLER

(71) Applicant: YAT WAI EDWIN KWONG, Hong Kong (HK)

(72) Inventor: YAT WAI EDWIN KWONG, Hong Kong (HK)

(21) Appl. No.: 13/302,776

(22) Filed: Nov. 22, 2011

(51) Int. Cl. B60R 21/01; B60R 21/02

(52) U.S. Cl. 701/45

(57) ABSTRACT

Strollers are provided for preventing harm to an infant when an accidental event occurs to the strollers. In one embodiment, a stroller is provided to include a wheelbase containing a set of wheels; a detachable seat attached onto the wheelbase, wherein an infant sits on the seat; an accelerometer attached to the wheelbase, wherein the accelerometer detects any flip over of the stroller; a bag filled with helium that is being attached to the seat; a GPS associated with the seat, and an antenna configured to transmit communication signals.

### FIELD OF THE INVENTION

This invention is generally related to a stroller providing safety mechanism. Specifically, but not limited to, this invention relates to detecting that a flip over occurs and reacting to the flip over. Further, the invention notifies the parents of the infant sitting on the stroller.

### BACKGROUND OF THE INVENTION

It is very common for parents like to put babies on baby strollers. Most baby strollers have wheels to support the weight of the babies sitting on top of the strollers. As we all know, baby requires special attention from parents, who have been very busy in taking care of the baby in many different perspectives. Thus, it is not surprising to find that parents forget to ensure proper safety measures have been made with respect to the babies sitting in the strollers. Further, most parents do not realize that certain events may cause irreparable harm or danger to the babies. For example, some parents may be found to leave their babies unattended. In this case, parents may put their children at risk because unattended strollers may accidentally roll down the road, without proper attention from the parents. There are many causes for this to happen. One circumstance includes faulty equipment. That can happen when wheels are malfunctioned and thus easily cause the strollers to flip over from one side to another. What if baby strollers flip over from one side to another? Babies sitting on the strollers may fall from the seats. The damages to the babies can be fatal. Currently, some would argue that baby strollers equipped with air bag may provide adequate protection that is being provided by air bags installed in cars. However, air bags equipped on strollers can be extremely dangerous because it has been known that air bags coming out of the wheel can hurt the passenger who is supposed to receive protection from, as the impact of air bag can be larger than needed. Therefore, a better mechanism is desired to protect infants or babies sitting on baby strollers.

### SUMMARY OF THE INVENTION

This invention is related to a stroller for preventing harm to an infant when an accidental event occurs to the stroller. Consistent with embodiments of the invention, the stroller may comprise: a wheelbase containing a set of wheels, including a first wheel, a second wheel, and a third wheel; and a detachable seat attached onto the wheelbase. The infant may sit on the seat; and an accelerometer may be included that being attached to the wheelbase, wherein the accelerometer detects any flip over of the stroller. The stroller also includes other elements, including: a bag filled with helium that is being attached to the seat, wherein the bag inflates when the accelerometer detects that the flip over has occurred, causing the seat and the infant to be suspended in air to prevent harm to the infant; a GPS associated with the seat, wherein the GPS locates current location of the seat and the baby that is suspending in the air; an antenna configured to transmit communication signals; a processor; and a memory storing instructions that cause the processor to execute a method.

One exemplary method comprises detecting that stroller are strolling on a surface, with the infant sitting on the seat; detecting that an event occurs, wherein the event includes: the stroller hits an obstacle; stroller is losing control; at least a wheel of the stroller skids; and the surface is rough; detecting that a flip over occurs to the stroller due to the occurring event, wherein the detection includes at least one of: detecting that the first wheel is off the ground; reacting to the flip over, as detected by the stroller, including: detaching the seat from the stroller; inflating the bag filled with helium; and ejecting the seat with the infant sitting on the seat, wherein the helium included in the inflated bag supports the seat and the infant being suspending in the air; and notifying a parent of the infant, including: using the current location of the infant.

In another embodiment, the method may comprise detecting that stroller are strolling on a surface, with the infant sitting on the detachable seat; detecting that an event occurs, wherein the event includes: the stroller hits an obstacle; stroller is losing control; at least a wheel of the stroller skids; and the surface is rough; detecting, with the accelerometer, that a flip over occurs to the stroller due to the occurring event, wherein the detection includes at least one of: detecting the first and second wheels are off the ground; reacting to the flip over, as detected by the stroller, including: detaching the detachable seat from the stroller; inflating the bag filled with helium; and ejecting the detachable seat with the infant sitting on the detachable seat, wherein the helium included in the inflated bag supports the detachable seat and the infant being suspending in the air; and notifying a parent of the infant, including: using the current location of the infant, by using the GPS receiver; and sending the current location of the infant to the parent, by using the antenna.

In yet another embodiment, the method comprises detecting that stroller are strolling on a surface, with the infant sitting on the detachable seat; detecting that an event occurs, wherein the event includes: the stroller hits an obstacle; stroller is losing control; at least a wheel of the stroller skids; and the surface is rough; detecting, with the accelerometer, that a flip over occurs to the stroller due to the occurring event, wherein the detection includes at least one of: detecting the first, second, and third wheels are off the ground; reacting to the flip over, as detected by the stroller, including: detaching the detachable seat from the stroller; inflating the bag filled with helium; and ejecting the detachable seat with the infant sitting on the detachable seat, wherein the helium included in the inflated bag supports the detachable seat and the infant being suspending in the air; and notifying a parent of the infant, including: using the current location of the infant, by using the GPS receiver; and sending the current location of the infant to the parent, by using the antenna.

Further, the method may alternatively comprise detecting that stroller are strolling on a surface, with the infant sitting on the detachable seat; detecting that an event occurs, wherein the event includes: the stroller hits an obstacle; stroller is losing control; at least a wheel of the stroller skids; and the surface is rough; detecting, with the accelerometer, that a flip over occurs to the stroller due to the occurring event, wherein the detection includes at least one of: detecting the stroller is slanted by over more than thirty degrees; reacting to the flip over, as detected by the stroller, including: detaching the detachable seat from the stroller; inflating the bag filled with helium; and ejecting the detachable seat with the infant sitting on the detachable seat, wherein the helium included in the inflated bag supports the detachable seat and the infant being suspending in the air; and notifying a parent of the infant, including: using the current location of the infant, by using the GPS receiver; and sending the current location of the infant to the parent, by using the antenna.

In yet another embodiment, the method comprises detecting that stroller are strolling on a surface, with the infant sitting on the detachable seat; detecting that an event occurs, wherein the event includes: the stroller hits an obstacle; stroller is losing control; at least a wheel of the stroller skids; and the surface is rough; detecting, with the accelerometer, that a flip over occurs to the stroller due to the occurring event, wherein the detection includes at least one of: detecting the first wheel is off the ground; detecting the first and second wheels are off the ground; detecting the first, second, and third wheels are off the ground; and detecting the stroller is slanted by over more than thirty degrees; reacting to the flip over, as detected by the stroller, including: detaching the detachable seat from the stroller; inflating the bag filled with helium; and ejecting the detachable seat with the infant sitting on the detachable seat, wherein the helium included in the inflated bag supports the detachable seat and the infant being suspending in the air; and notifying a parent of the infant, including: using the current location of the infant, by using the GPS receiver; and sending the current location of the infant to the parent, by using the antenna.

### BRIEF DESCRIPTION OF THE DRAWINGS

FIG. 1 illustrates an exemplary stroller, consistent with embodiments of the invention.

### DETAILED DESCRIPTION

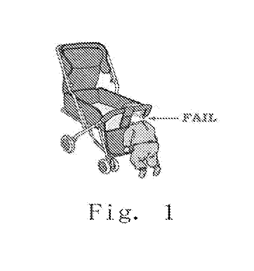

Referring to FIG. 1, a stroller for preventing harm to an infant is provided. In this example, the stroller comprises a wheelbase containing a set of wheels, including a first wheel, a second wheel, and a third wheel; a detachable seat attached onto the wheelbase, wherein an infant sits on the seat; an accelerometer attached to the wheelbase, wherein the accelerometer detects any flip over of the stroller; a bag filled with helium that is being attached to the seat, wherein the bag inflates when the accelerometer detects that the flip over has occurred, causing the seat and the infant to be suspended in air to prevent harm to the infant; a GPS associated with the seat, wherein the GPS locates current location of the seat and the baby that is suspending in the air; an antenna configured to transmit communication signals; a processor; and a memory storing instructions that cause the processor to execute a method, the method comprising: detecting that stroller are strolling on a surface, with the infant sitting on the seat; detecting that an event occurs, wherein the event includes: the stroller hits an obstacle; stroller is losing control; at least a wheel of the stroller skids; and the surface is rough; detecting that a flip over occurs to the stroller due to the occurring event, wherein the detection includes at least one of: detecting that the first wheel is off the ground; reacting to the flip over, as detected by the stroller, including: detaching the seat from the stroller; inflating the bag filled with helium; and ejecting the seat with the infant sitting on the seat, wherein the helium included in the inflated bag supports the seat and the infant being suspending in the air; and notifying a parent of the infant, including: using the current location of the infant.

In a variant of this invention, the stroller may include a detachable seat attached onto the wheelbase, wherein an infant sits on the detachable seat; an accelerometer attached to the wheelbase, wherein the accelerometer detects any flip over of the stroller; a bag filled with helium that is being attached to the detachable seat, wherein the bag inflates when the accelerometer detects that the flip over has occurred, causing the detachable seat and the infant to be suspended in air to prevent harm to the infant; a GPS receiver associated with the detachable seat, wherein the GPS locates current location of the detachable seat and the baby that is suspending in the air; an antenna configured to transmit communication signals; a processor; and a memory storing instructions that cause the processor to execute a method, the method comprising: detecting that stroller are strolling on a surface, with the infant sitting on the detachable seat; detecting that an event occurs, wherein the event includes: the stroller hits an obstacle; stroller is losing control; at least a wheel of the stroller skids; and the surface is rough; detecting, with the accelerometer, that a flip over occurs to the stroller due to the occurring event, wherein the detection includes at least one of: detecting the first and second wheels are off the ground; reacting to the flip over, as detected by the stroller, including: detaching the detachable seat from the stroller; inflating the bag filled with helium; and ejecting the detachable seat with the infant sitting on the detachable seat, wherein the helium included in the inflated bag supports the detachable seat and the infant being suspending in the air; and notifying a parent of the infant, including: using the current location of the infant, by using the GPS receiver; and sending the current location of the infant to the parent, by using the antenna.

The inventive stroller may be implemented with other features. For example, the stroller may be configured to perform detecting that stroller are strolling on a surface, with the infant sitting on the detachable seat; detecting that an event occurs, wherein the event includes: the stroller hits an obstacle; stroller is losing control; at least a wheel of the stroller skids; and the surface is rough; detecting, with the accelerometer, that a flip over occurs to the stroller due to the occurring event, wherein the detection includes at least one of: detecting the first, second, and third wheels are off the ground; reacting to the flip over, as detected by the stroller, including: detaching the detachable seat from the stroller; inflating the bag filled with helium; and ejecting the detachable seat with the infant sitting on the detachable seat, wherein the helium included in the inflated bag supports the detachable seat and the infant being suspending in the air; and notifying a parent of the infant, including: using the current location of the infant, by using the GPS receiver; and sending the current location of the infant to the parent, by using the antenna.

In another example, the stroller can be used for detecting that stroller are strolling on a surface, with the infant sitting on the detachable seat; detecting that an event occurs, wherein the event includes: the stroller hits an obstacle; stroller is losing control; at least a wheel of the stroller skids; and the surface is rough; detecting, with the accelerometer, that a flip over occurs to the stroller due to the occurring event, wherein the detection includes at least one of: detecting the stroller is slanted by over more than thirty degrees; reacting to the flip over, as detected by the stroller, including: detaching the detachable seat from the stroller; inflating the bag filled with helium; and ejecting the detachable seat with the infant sitting on the detachable seat, wherein the helium included in the inflated bag supports the detachable seat and the infant being suspending in the air; and notifying a parent of the infant, including: using the current location of the infant, by using the GPS receiver; and sending the current location of the infant to the parent, by using the antenna.

The stroller may run into some unexpected events. In one situation, the stroller may accidentally hit an obstacle and causing the stroller to lose control. In such a case, the wheels included in the stroller would skid, and the stroller is configured to perform detecting, with the accelerometer, that a flip over occurs to the stroller due to the occurring event, wherein the detection includes at least one of: detecting the first wheel is off the ground; detecting the first and second wheels are off the ground; detecting the first, second, and third wheels are off the ground; and detecting the stroller is slanted by over more than thirty degrees; reacting to the flip over, as detected by the stroller, including: detaching the detachable seat from the stroller; inflating the bag filled with helium; and ejecting the detachable seat with the infant sitting on the detachable seat, wherein the helium included in the inflated bag supports the detachable seat and the infant being suspending in the air; and notifying a parent of the infant, including: using the current location of the infant, by using the GPS receiver; and sending the current location of the infant to the parent, by using the antenna.

What is claimed is:

1. A stroller for preventing harm to an infant when an accidental event occurs to the stroller, comprising:
a wheelbase containing a set of wheels, including a first wheel, a second wheel, and a third wheel;
a detachable seat attached onto the wheelbase, wherein an infant sits on the seat;
an accelerometer attached to the wheelbase, wherein the accelerometer detects any flip over of the stroller;
a bag filled with helium that is being attached to the seat, wherein the bag inflates when the accelerometer detects that the flip over has occurred, causing the seat and the infant to be suspended in air to prevent harm to the infant;
a GPS associated with the seat, wherein the GPS locates current location of the seat and the baby that is suspending in the air;
an antenna configured to transmit communication signals;
a processor; and
a memory storing instructions that cause the processor to execute a method.

2. The system of claim 1, wherein the method comprises:
detecting that stroller are strolling on a surface, with the infant sitting on the seat;
detecting that an event occurs, wherein the event includes:
the stroller hits an obstacle;
stroller is losing control;
at least a wheel of the stroller skids; and
the surface is rough;
detecting that a flip over occurs to the stroller due to the occurring event, wherein the detection includes at least one of:
detecting that the first wheel is off the ground;
reacting to the flip over, as detected by the stroller, including:
detaching the seat from the stroller;
inflating the bag filled with helium; and
ejecting the seat with the infant sitting on the seat, wherein the helium included in the inflated bag supports the seat and the infant being suspending in the air; and
notifying a parent of the infant, including:
using the current location of the infant.

3. The system of claim 1, wherein the method comprises:
detecting that stroller are strolling on a surface, with the infant sitting on the detachable seat;
detecting that an event occurs, wherein the event includes:
the stroller hits an obstacle;
stroller is losing control;
at least a wheel of the stroller skids; and
the surface is rough;
detecting, with the accelerometer, that a flip over occurs to the stroller due to the occurring event, wherein the detection includes at least one of:
detecting the first and second wheels are off the ground;
reacting to the flip over, as detected by the stroller, including:
detaching the detachable seat from the stroller;
inflating the bag filled with helium; and
ejecting the detachable seat with the infant sitting on the detachable seat, wherein the helium included in the inflated bag supports the detachable seat and the infant being suspending in the air; and
notifying a parent of the infant, including:
using the current location of the infant, by using the GPS receiver; and
sending the current location of the infant to the parent, by using the antenna.

4. The system of claim 1, wherein the method comprises:
detecting that stroller are strolling on a surface, with the infant sitting on the detachable seat;
detecting that an event occurs, wherein the event includes:
the stroller hits an obstacle;
stroller is losing control;
at least a wheel of the stroller skids; and
the surface is rough;
detecting, with the accelerometer, that a flip over occurs to the stroller due to the occurring event, wherein the detection includes at least one of:
detecting the first, second, and third wheels are off the ground;
reacting to the flip over, as detected by the stroller, including:
detaching the detachable seat from the stroller;
inflating the bag filled with helium; and
ejecting the detachable seat with the infant sitting on the detachable seat, wherein the helium included in the inflated bag supports the detachable seat and the infant being suspending in the air; and
notifying a parent of the infant, including:
using the current location of the infant, by using the GPS receiver; and
sending the current location of the infant to the parent, by using the antenna.

5. The system of claim 1, wherein the method comprises:
detecting that stroller are strolling on a surface, with the infant sitting on the detachable seat;
detecting that an event occurs, wherein the event includes:
the stroller hits an obstacle;
stroller is losing control;
at least a wheel of the stroller skids; and
the surface is rough;
detecting, with the accelerometer, that a flip over occurs to the stroller due to the occurring event, wherein the detection includes at least one of:
detecting the stroller is slanted by over more is than thirty degrees;
reacting to the flip over, as detected by the stroller, including:
detaching the detachable seat from the stroller;
inflating the bag filled with helium; and
ejecting the detachable seat with the infant sitting on the detachable seat, wherein the helium included in the inflated bag supports the detachable seat and the infant being suspending in the air; and
notifying a parent of the infant, including:
using the current location of the infant, by using the GPS receiver; and
sending the current location of the infant to the parent, by using the antenna.

6. The system of claim 1, wherein the method comprises:
detecting that stroller are strolling on a surface, with the infant sitting on the detachable seat;
detecting that an event occurs, wherein the event includes:
the stroller hits an obstacle;
stroller is losing control;
at least a wheel of the stroller skids; and
the surface is rough;
detecting, with the accelerometer, that a flip over occurs to the stroller due to the occurring event, wherein the detection includes at least one of:
detecting the first wheel is off the ground;
detecting the first and second wheels are off the ground;
detecting the first, second, and third wheels are off the ground; and
detecting the stroller is slanted by over more than thirty degrees;
reacting to the flip over, as detected by the stroller, including:
detaching the detachable seat from the stroller;
inflating the bag filled with helium; and
ejecting the detachable seat with the infant sitting on the detachable seat, wherein the helium included in the inflated bag supports the detachable seat and the infant being suspending in the air; and
notifying a parent of the infant, including:
using the current location of the infant, by using the GPS receiver; and
sending the current location of the infant to the parent, by using the antenna.
